(19) United States
(12) Patent Application Publication
(10) Pub. No.: US 2006/0149931 A1
(43) Pub. Date: Jul. 6, 2006

(54) Runahead execution in a central processing unit

(76) Inventors: Akkary Haitham, Portland, OR (US); Doron Orenstein, Haifa (IL); Ravi Rajwar, Portland, OR (US); Srikanth T. Srinivasan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/024,164

(22) Filed: Dec. 28, 2004

(51) Int. Cl. G06F 9/30

(52) U.S. Cl. 712/218

(57) ABSTRACT

According to one embodiment, a method is disclosed. The method includes detecting a load miss at a central processing unit (CPU), stalling a read only buffer (ROB), speculatively retiring an instruction causing the ROB stall and subsequent instructions, keeping registers that have not been renamed in the ROB upon retirement, and flushing the CPU pipeline upon receiving data from the load miss.

### FIELD OF THE INVENTION

The present invention relates to computer systems; more particularly, the present invention relates to central processing units (CPUs).

### BACKGROUND

Runahead execution in computer system CPUs is implemented to tolerate long latency load misses in a CPU cache that have to be serviced by main memory. Specifically, runahead execution uses idle clock cycles encountered due to reorder buffer full stall resulting from the long latency load miss blocking in-order retirement for hundreds of cycles while data is fetched from memory.

Proposed runahead execution models include checkpointing the register state, speculatively executing instructions in the shadow of the load miss (e.g., after the missed load) until the miss data is fetched, ensuring that the speculative runahead execution does not cause updates to memory state, using poison bits to ensure the scheduler does not get blocked, discarding the speculative runahead state when miss data returns, restoring the checkpointed register state, and restarting execution.

The problem with the proposed runahead schemes is that the steps of checkpointing the register state and employing poison bits to ensure that the speculative runahead execution does not stall the scheduler require additional hardware, which increases the complexity and cost of the CPU design.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates a block diagram of one embodiment of a CPU;

FIG. 3 illustrates a block diagram of one embodiment of a fetch/decode unit;

FIG. 4 illustrates a of one embodiment of a retire unit;

FIG. 5 illustrates a flow diagram for embodiment of runahead execution;

FIG. 6 illustrates one embodiment of a reorder buffer; and

FIG. 7 illustrates another embodiment of a reorder buffer.

### DETAILED DESCRIPTION

Runahead execution in a CPU is described. The runahead execution process includes stalling register file updates when a load miss reaches the head of a reorder buffer. Subsequently, speculative runahead and retirement of the load miss and instructions after the miss is continued without updating the register file or issuing stores to memory. Un-renamed registers are kept in the reorder buffer when they are retired. This is done by copying the un-renamed registers from the head to the tail of the reorder buffer via reorder buffer head and tail pointers adjustment. Next, the pipeline is flushed when the data miss returns. Finally, execution is restarted using the frozen state at the load miss in the register file.

In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

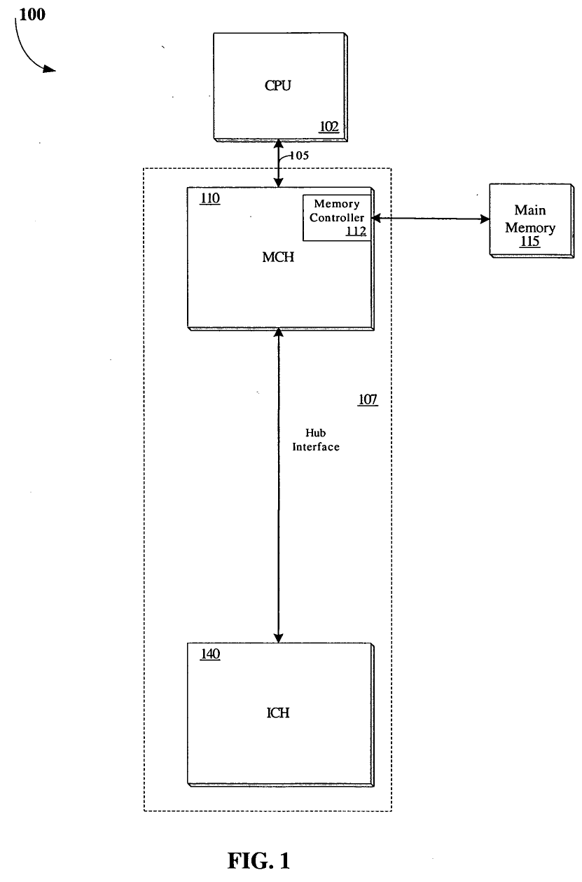

FIG. 1 is a block diagram of one embodiment of a computer system 100. Computer system 100 includes a central processing unit (CPU) 102 coupled to bus 105. A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100.

In one embodiment, main system memory 115 includes dynamic random access memory (DRAM); however, main system memory 115 may be implemented using other memory types. Additional devices may also be coupled to bus 105, such as multiple CPUs and/or multiple system memories. MCH 110 is coupled to an input/output control hub (ICH) 140 via a hub interface. ICH 140 provides an interface to input/output (I/O) devices within computer system 100.

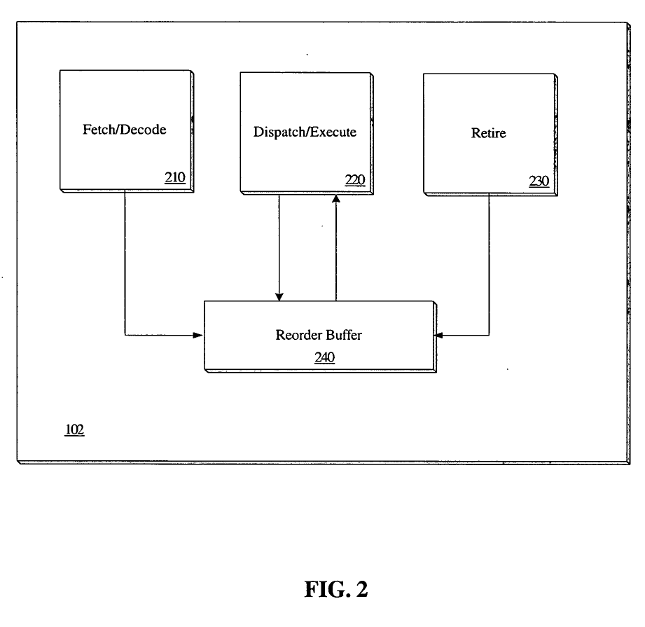

FIG. 2 illustrates a block diagram of one embodiment of CPU 102. CPU 102 includes fetch/decode unit 210, dispatch/execute unit 220, retire unit 230 and reorder buffer (ROB) 240. Fetch/decode unit 210 is an in-order unit that takes a user program instruction stream as input from an instruction cache (not shown) and decodes the stream into a series of micro-operations (uops) that represent the dataflow of that stream.

FIG. 3 illustrates a block diagram for one embodiment of fetch/decode unit 210. Fetch/decode unit 210 includes instruction cache (Icache) 310, instruction decoder 320, branch target buffer 330, instruction sequencer 340 and register alias table (RAT) 350. Icache 310 is a local instruction cache that fetches cache lines of instructions based upon an index provided by branch target buffer 330.

The instructions are presented to decoder 320, which converts the instructions into uops. Some instructions are decoded into one to four uops using microcode provided by sequencer 240. The uops are queued and forwarded to RAT 350 where register references are converted to physical register references. The uops are subsequently transmitted to ROB 240.

Referring back to FIG. 2, dispatch/execute unit 220 is an out of order unit that accepts a dataflow stream, schedules execution of the uops subject to data dependencies and resource availability and temporarily stores the results of speculative executions. Retire unit 230 is an in order unit that commits (retires) the temporary, speculative results to permanent states.

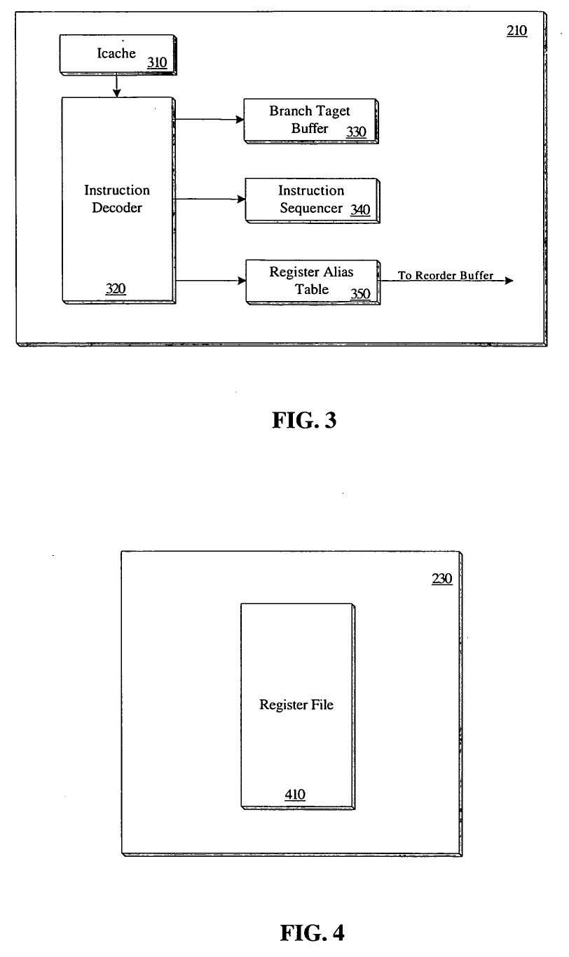

FIG. 4 illustrates a block diagram for one embodiment of retire unit 230. Retire unit 230 includes a register file (RF) 410. Retire unit 230 reads ROB 240 for potential candidates for retirement and determines which of these candidates are next in the original program order. The results of the retirement are written to RF 410.

ROB 240 is a reorder mechanism that maintains an architectural state by effectively keeping instruction results provisional until earlier instruction results are known. According to one embodiment, ROB 240 is implemented to facilitate runahead execution at CPU 102, as will be discussed in greater detail below.

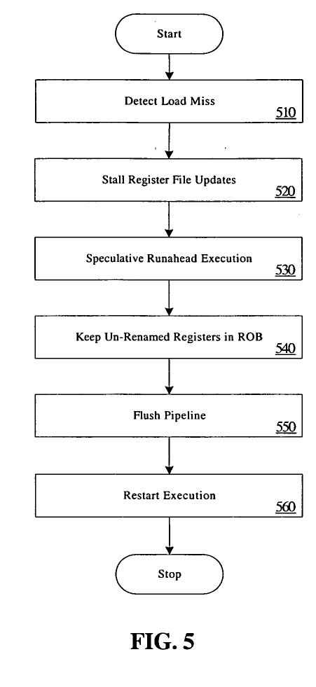

As discussed above, runahead execution uses idle clock cycles encountered due to reorder buffer full stall. These stalls are a result of a long latency load miss that blocks in-order retirement for hundreds of cycles while data is fetched from main memory. FIG. 5 illustrates a flow diagram for embodiment of runahead execution. At processing block 510, a load miss is detected. At processing block 520, RF 410 updates are stalled when a load miss reaches the head of a ROB 240.

At processing block 530, speculative runahead and retirement of the load miss and instructions after the miss is continued. According to one embodiment, the speculative runahead and retirement is performed without updating RF 410 or issuing stores to memory 115. At processing block 540, registers in RF 410 that have not been renamed are kept in ROB 240 when they are retired. In one embodiment, this is done by copying the un-renamed registers from the head to the tail of ROB 410 via head and tail pointer adjustments.

At processing block 550, the CPU 102 pipeline is flushed when the data from the load miss returns from memory 115. At processing block 560, execution is restarted using the frozen state at the load miss in RF 410. In one embodiment, register data is forwarded from producer to consumer uops to implement runahead execution. Since RF 410 updates are frozen in runahead mode to avoid the implementation of checkpointing the register state, ROB 240, and a writeback data bypass, is used to forward register values. As a result, the retirement process is modified.

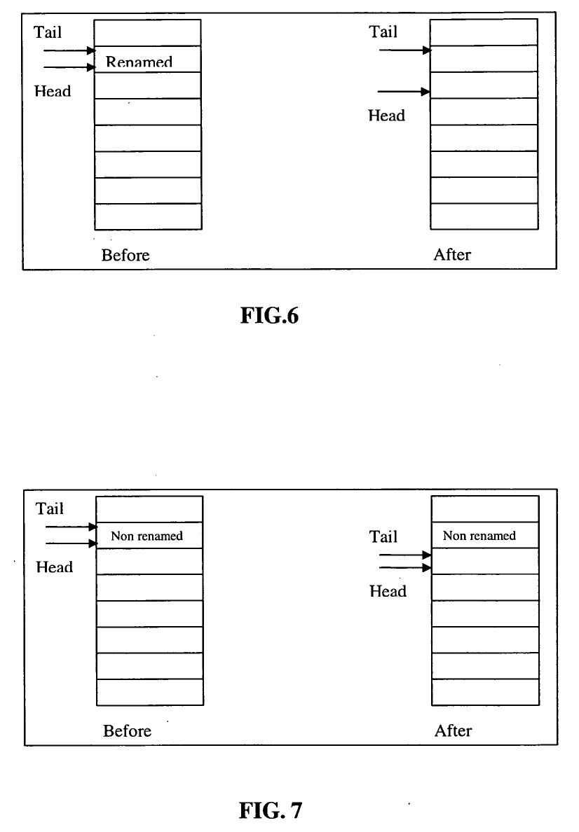

In one embodiment, whenever a uop has a logical register destination that has been renamed the uop is safely retired, while its value is discarded. Further, newly fetched uops do not need this register since it has been renamed, while readers waiting in a reservation station in dispatch/execute engine 220 will have already captured the value from either ROB 240 or from the writeback data bypass. FIG. 6 illustrates one embodiment of the action of retiring a renamed register in ROB 240 when ROB 240 is full. As shown in FIG. 6, the entry is freed and the value is discarded.

In a further embodiment, when a uop has a logical register that has not been renamed, retirement is stalled until it is renamed, or until ROB 240 fills up. If the register is not renamed when ROB 420 is full, retirement is unstalled by advancing the head-pointer of ROB 240, without discarding the uop destination register value. In one embodiment, this is done by advancing both the ROB 240 head pointer and tail pointer.

Advancing both pointers effectively move the uop and its value from the head of ROB 240 to the tail without actually reading and writing the ROB 240 entry. A RAT 350 rename table maintains the proper position for that logical register since the uop is moved from the head of ROB 240 to the tail without changing location in ROB 240. FIG. 7 illustrates one embodiment of the action of retiring an un-renamed register in ROB 240 when ROB 240 is full. As shown in FIG. 7, the tail pointer is advanced with the head pointer leaving the uop and its output in ROB 240 and in RAT 350 for future readers.

Other modifications are also implemented to enable runahead execution in CPU 102. In one embodiment, uops with renamed destination in the ROB 240 register forwarding mechanism are identified. To avoid having to increase the number of RAT 350 ports, in this embodiment, runahead is executed at half rename bandwidth and read ports becoming available are used to read RAT 350 for both sources as well as destinations of renamed uops. The ROB 240 entry in RAT 350 indexed by a logical destination is a renamed uop ROB 240 entry. A renamed bit in that ROB 240 entry may be set to mark entry as renamed. Note that in other embodiments, the number of RAT ports may simply be increased.

In a further embodiment, data from speculative stores to speculative loads are forwarded in runahead. In such an embodiment, speculative stores are stored in a store buffer even after their “pseudo-retirement” in ROB 240 to allow forwarding to any loads that may need the store data.

However, when the store buffer fills up, the oldest runahead stores are discarded without issuing these stores to memory 113, thus making room for new runahead stores. As a result of this mechanism, runahead loads that are to receive data from discarded stores will read stale data from the cache instead. Further, since the RF 240 state is frozen at the load miss point, jump execution clears JEClear) are disabled while in runahead mode.

The above-described mechanism enables runahead execution while avoiding checkpointing and restoring the register file to execute runahead. Further, a fast, non-costly mechanism is provided for propagating register values from producer to consumer uops through the ROB without having to update the register file at retirement.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
detecting a load miss at a central processing unit (CPU);
stalling a reorder buffer (ROB);
speculatively retiring an instruction causing the ROB stall and subsequent instructions;
keeping registers that have not been renamed in the ROB upon retirement; and
flushing the CPU pipeline upon receiving data from the load miss.

2. The method of claim 1 wherein stalling the ROB comprises stalling register file updates at a register file when the load miss reaches the head of the ROB.

3. The method of claim 1 wherein the speculative runahead and retirement of the instruction causing the ROB stall and subsequent instructions is performed without updating the register file.

4. The method of claim 3 wherein the speculative runahead and retirement of the instruction causing the ROB stall and subsequent instructions is further performed without issuing stores to a memory device.

5. The method of claim 3 further comprising restarting execution using the stalled state at the instruction causing the ROB stall in the register file.

6. The method of claim 1 wherein keeping registers in ROB upon retirement comprises copying the registers that have not been renamed via head and tail pointer adjustments from the head to the tail of the ROB.

7. The method of claim 1 wherein speculatively running retirement of the instruction causing the ROB stall and subsequent instructions further comprises forwarding register data from producer micro-operations (uops) to consumer uops.

8. The method of claim 7 further comprising retiring a uop whenever the uop has a logical register destination that has been renamed.

9. The method of claim 7 further comprising reclaiming an ROB entry for a uop whenever the uop has a logical register that has not been renamed.

10. The method of claim 9 further comprising stalling retirement for a uop until the ROB fills up.

11. The method of claim 10 further comprising un-stalling the retirement for the uop if the ROB fills up by advancing a head-pointer of the ROB.

12. The method of claim 11 further comprising advancing the head-pointer of the ROB without discarding the uop destination register value.

13. A computer system comprising:
a main memory device, and
a central processing unit (CPU), coupled to the main memory device, including:
a read only buffer (ROB);
a register file; and
and execution unit to perform speculative runahead execution by stalling the ROB.

14. The computer system of claim 13 wherein the CPU further comprises a retire unit to speculatively retire an instruction causing the ROB stall and subsequent instructions during the speculative runahead execution.

15. The computer system of claim 14 wherein the speculative runahead execution and retirement of the instruction causing the ROB stall and subsequent instructions is performed without updating the register file or storing to the main memory device.

16. The computer system of claim 15 wherein the ROB maintains registers that have not been renamed upon retirement by copying the registers that have not been renamed via head and tail pointer adjustments from the head to the tail of the ROB.

17. The computer system of claim 13 wherein the execution restarts execution using the stalled state at the instruction causing the ROB stall in the register file.

18. The computer system of claim 13 wherein the execution unit performs the speculative runahead execution by forwarding register data from producer micro-operations (uops) to consumer uops.

19. A central processing unit (CPU) comprising:
a read only buffer (ROB); and
a register file; and
and execution unit to perform speculative runahead execution by stalling the ROB.

20. The CPU of claim 19 wherein the execution unit stalls the ROB by stalling register file updates at the register file when the load miss reaches the head of the ROB.

21. The CPU of claim 19 further comprising a retire unit to retire the instruction causing the ROB stall and subsequent instructions during the speculative runahead execution.

22. The CPU of claim 21 wherein the speculative runahead execution and retirement of the instruction causing the ROB stall and subsequent instructions is performed without updating the register file or storing to the main memory device.

23. The CPU of claim 19 wherein the ROB maintains registers that have not been renamed upon retirement by copying the registers that have not been renamed via head and tail pointer adjustments from the head to the tail of the ROB.
